(19) United States
(12) Patent Application Publication
(10) Pub. No.: US 2025/0303508 A1
(43) Pub. Date: Oct. 2, 2025

(54) MODULAR SUPPORT SYSTEM COMPRISING A SUPPORT BASE STRUCTURE COMPOSED OF OCTAGONAL PROFILES

(71) Applicants: thyssenkrupp Automotive Body Solutions GmbH, Heilbronn (DE); SPRINGER GmbH, Stuhr (DE); thyssenkrupp AG, Essen (DE)

(72) Inventors: Jens STOLZENBURG, Ilsfeld (DE); Uwe FOELL, Wuestenrot (DE); German FUCHS, Marpingen (DE); Uwe SPRINGER, Stuhr (DE); Volker ALBRECHT-BUENSTORF, Syke (DE); Lars KERBER, Bremen (DE)

(73) Assignees: thyssenkrupp Automotive Body Solutions GmbH, Heilbronn (DE); SPRINGER GmbH, Stuhr (DE); thyssenkrupp AG, Essen (DE)

(21) Appl. No.: 18/864,443

(22) PCT Filed: May 2, 2023
(86) PCT No.: PCT/EP2023/061517

§ 371 Date: Nov. 8, 2024

(30) Foreign Application Priority Data
May 12, 2022 (DE) 10 2022 204 659.5

(51) Int. Cl. B23Q 1/26

(52) U.S. Cl. CPC B23Q 1/26

(57) ABSTRACT

A modular carrying system for carrying tools and/or workpieces so that they can be worked on comprises a plurality of octagonal profiles each with eight side surfaces, which each have a multiplicity of arrangement holes. A plurality of the octagonal profiles here are connected to one another via connecting elements to form a basic carrying structure. The connecting elements each have two arrangement portions, which each engage around three adjacent side surfaces of an octagonal profile, wherein the connecting elements each connect two octagonal profiles in such a manner that the arrangement portions are each spaced apart from the central side surface of the three adjacent side surfaces of a respective octagonal profile and are arranged in a form-fitting manner on the adjacent side surfaces of a respective octagonal profile via the arrangement holes in the outer side surfaces of the adjacent side surfaces.

The invention relates to a modular carrying system for carrying tools and/or for carrying workpieces so that they can be worked on, having a plurality of octagonal profiles each with eight side surfaces, which each have a multiplicity of defined-position arrangement holes. A plurality of the octagonal profiles here are connected to one another via connecting elements to form a basic carrying structure, wherein the connecting elements each have two arrangement portions, which each engage around three adjacent side surfaces of an octagonal profile. Such carrying systems are used in particular in the automotive industry for working on vehicle-body components for vehicle production.

A possible configuration of a carrying system which is constructed in modular form from a plurality of octagonal profiles and is intended for fitting on robots and for the attachment of tools, such as clamping, gripping and suction devices, is known for example from DE 299 05 687 U1. DE 10 2013 006 723 A1 describes an advantageous configuration of an octagonal profile for such a carrying system. A further possible configuration of a modular carrying system for fixing working tools for the bodyshell manufacturing of motor-vehicle bodies is disclosed in EP 2 604 381 B1. In addition, EP 1 533 072 B1 describes a system of elements which is intended for constructing such a carrying system.

The problem is that, in particular in the case of new electric vehicles, the weight of the battery necessitates use of particularly strengthened and therefore also relatively heavy vehicle bodies and underbodies, for which the previously known carrying systems are not designed, in particular if the vehicles are vans or SUVs (SUV: Sport Utility Vehicle). This means that the carrying systems have to be adapted, which in the case of the aforementioned carrying systems also means an increase in weight, as a result of which sometimes the loading capacities of the robots used reach their limits.

Against this background, it is an object of the present invention to provide an improved modular carrying system. The improvement preferably resides in a simplified construction of the carrying system, wherein the carrying system provides a higher loading capability, preferably along with reduced weight, and advantageously has a reduced carbon footprint.

This object is achieved by a modular carrying system as claimed in claim 1. Further advantageous configurations of the invention are described in the dependent claims and the description and are also illustrated in the figures.

The proposed solution provides a modular carrying system which is intended for carrying tools and/or for carrying workpieces so that they can be worked on and comprises a plurality of octagonal profiles each with eight side surfaces, which each have a multiplicity of arrangement holes. A plurality of the octagonal profiles here are connected to one another via connecting elements to form a basic carrying structure, wherein the connecting elements each have two arrangement portions, which each engage around three adjacent side surfaces of an octagonal profile. According to the invention, the connecting elements each connect two octagonal profiles in such a manner that the arrangement portions are each spaced apart, in particular generously spaced apart, from the central side surface of the three adjacent side surfaces of a respective octagonal profile and are arranged in a form-fitting manner on the outer side surfaces of the adjacent side surfaces of a respective octagonal profile via the arrangement holes in the outer side surfaces of the adjacent side surfaces. Since therefore only two surfaces of the arrangement portions butt against the octagonal profile, it is advantageously possible to realize relatively large tolerances, because there is no geometrical over-determination. This advantageously simplifies the construction of the carrying system. In addition, lines for grippers and/or other functional elements which can be arranged on the carrying system can advantageously be guided through the cavities thus formed between the arrangement portion and octagonal profile. This advantageously makes it possible to do away with, or at least reduce the number of, additional guides for the lines, which results in the weight of the carrying system being reduced. According to an advantageous configuration, provision is made for the arrangement portions to be each spaced apart from the central side surface of the three adjacent side surfaces of a respective octagonal profile by 0.5 mm (mm: millimeter) to 20 mm, furthermore in particular to be spaced apart by 1 mm to 5 mm.

In particular, the octagonal profiles of the carrying system are of hollow design, wherein a supporting structure can be present in the interior. The arrangement holes in the side surfaces of the octagonal profiles are advantageously in a defined position, in particular at equidistant intervals, wherein preferably each side surface has a row of arrangement holes, so that advantageously always two arrangement holes in two side surfaces are located opposite one another in a pair. The arrangement holes are advantageously designed in the form of threaded bores. It is also advantageous for the octagonal profiles to have a material accumulation in the interior, beneath the side surfaces. The arrangement holes advantageously pass through the respective material accumulation. This advantageously makes it possible for internal threads to be introduced into the arrangement holes, advantageously without increasing the overall wall thickness of the octagonal profiles. Accordingly, provision is made in particular for the arrangement holes to have an internal thread. It is also advantageous for at least some of the connecting elements, in particular all of the connecting elements, to be arranged on the octagonal profiles by way of screws with an anti-friction coating. The anti-friction coating advantageously increases the prestressing force of each screw connection and therefore increases the level of rigidity of the system of elements as a whole.

Furthermore, provision is made in particular for the carrying system to comprise a main body, in particular a main-body plate, wherein the main body is preferably arranged on the basic carrying structure. The main body is advantageously a gripper-attachment plate. In particular, provision is made for a robot to be connected on the main body. Furthermore, end effectors are advantageously attached via vertical tubes, which are preferably fastened on the carrying system.

The carrying system can advantageously also be used for devices, component grippers, stands, racks, shelves, or other similar related applications in vehicle-body manufacturing, as operating equipment for vehicle production, but in particular as a carrying system for transporting sheet-metal parts for vehicle-body manufacturing, furthermore in particular for the handling, positioning and fixing of such parts. All of this is always based on the use of polygonal hollow profiles with circumferential arrangement holes, in particular with unit-spacing bores forming the arrangement holes, and the screw connection of connecting elements. The screw connection of the connecting elements when the carrying system is being constructed advantageously takes place in a form-fitting manner on a maximum of two non-abutting surfaces of the polygonal hollow profile. Lengthwise, the connecting elements are advantageously positioned at specific unit spacings by means of centering pins when the carrying system is being constructed. Since the connecting elements do not surround the polygonal hollow profile, in particular a complex carrying system can be produced. The connecting elements advantageously follow the bionics. On account of their configuration, which will be described in yet more detail hereinbelow, all the connecting elements advantageously have a very high level of rigidity. Even in the case of high loading, the levels of stressing which occur are advantageously considerably lower in comparison with connecting elements which comprise purely regular geometries. The properties of the connecting elements, which will be described in even more detail hereinbelow, advantageously make it possible to cut back on connecting elements throughout the carrying system in comparison with conventional carrying systems. This advantageously further reduces the overall mass of the carrying system and advantageously cuts back on resources. In particular, provision is made for it also to be possible for the carrying system to comprise further connecting elements, wherein, rather than connecting two octagonal profiles to one another, such a further connecting element connects in particular a functional element to an octagonal profile. The arrangement region for arranging the further connecting element on the octagonal profile here is advantageously of the same design as the corresponding arrangement region of the connecting elements which connect two octagonal profiles to one another. The connecting elements, in particular the further connecting elements, advantageously have additional features for further use, in particular additional bores and/or grooves, which can be provided for example for cable-guiding purposes. The connecting elements are made in particular from steel or aluminum.

A further advantageous configuration of the carrying system makes provision for at least some of the connecting elements to be designed in the form of first connectors for the right-angled connection of two octagonal profiles in the same arrangement plane. In particular, such first connectors are provided in order to connect octagonal profiles to one another to form the basic carrying structure. In addition, or as an alternative, provision is made for at least some of the connecting elements to be designed in the form of second connectors for the right-angled connection of two octagonal profiles in arrangement planes which are offset parallel in relation to one another. In particular, both first connectors and second connectors are used in a carrying system. The different connectors here advantageously increase the ability to adapt to different requirements which the carrying system has to meet. The provision of different kinds of connector makes it possible for the latter also advantageously to be optimized in terms of weight for the respective purpose. In particular provided are further connectors which, rather than being designed for the right-angled connection of two octagonal profiles, are designed in particular for connecting octagonal profiles at an angle between 10° and 80°, in particular for connecting octagonal profiles at an angle of 20°, 30°, 45° and/or 60°.

In particular, provision is also made for the carrying system to comprise octagonal profiles with different widths across their flats, and therefore in particular with different circumferences, in particular octagonal profiles with a first width across their flats and octagonal profiles with a second width across their flats. The first width across the flats is in particular between 30 mm (mm: millimeter) and 80 mm. The second width across the flats is in particular between 50 mm and 160 mm. In particular, provision is made here for the first width across the flats to be smaller than the second width across the flats. In particular, an octagonal profile can also be designed in the form of a double profile, in particular in the form of a double profile with a width across the flats of 2×80 mm. Relatively rigid profile-tube geometries, in particular two octagonal profiles combined one above the other, also constitute a further advantageous configuration, in particular in order to increase moments of resistance in specific loading directions. At least some of the first connectors and/or at least some of the second connectors advantageously connect two octagonal profiles with different circumferences. The connection of two different widths across the flats of the octagonal profiles can advantageously have a positive effect on reducing the overall weight of the carrying system, with the level of rigidity of the carrying system being taken into account in the process.

In addition, or as an alternative, provision is made for at least some of the first connectors and/or at least some of the second connectors to connect two octagonal profiles with the same width across their flats. The first connectors and the second connectors here are advantageously each adapted accordingly, that is to say a first connector which connects to one another two octagonal profiles with the same width across their flats differs from a first connector which connects to one another two octagonal profiles with different widths across their flats. The same applies in particular to the second connectors.

According to a further advantageous configuration, the arrangement portions of the first connectors are arranged at right angles in relation to one another. In particular, the arrangement portions of the first connectors each comprise continuous outer portions, which butt in a form-fitting manner against the outer side surfaces of the adjacent side surfaces, and inner portions, which connect the outer portions. The outer portions here have fastening holes, which are designed to correspond in particular to the arrangement holes, wherein the first connectors are arranged on the octagonal profiles preferably via bolts, in particular threaded bolts, which are guided through the fastening holes and are connected to the arrangement holes. In particular, the threaded bolts are screws with an anti-friction coating. The anti-friction coating advantageously increases the prestressing force of each screw connection and therefore increases the level of rigidity of the system of elements as a whole. The inner portions of the arrangement portions each advantageously have a clearance, in particular an essentially rectangular clearance with preferably rounded corners. This advantageously reduces the weight of the first connectors, in particular without the loading capability of the first connectors being lost. In particular, provision is made for the clearance to take up 20% to 60% of the surface area of a respective inner portion, furthermore in particular 30% to 45% of the surface area of a respective inner portion. The clearance here is advantageously defined such that the strength of the connectors is of sufficient magnitude.

It is also advantageous for the first connectors to have a connecting crosspiece, which connects the outer ends of the inner portions. This advantageously increases the loading capability of a respective connector to a pronounced extent. In particular, however, the region between the connecting crosspiece and the arrangement portions, as seen in the direction of the longitudinal extent of the connecting crosspiece, is free of material, so that the first connectors are nevertheless of only low weight overall, in particular in comparison with connectors which are known in the prior art for the purpose of connecting octagonal profiles.

According to an advantageous development, a connecting crosspiece of a respective first connector which connects to one another two octagonal profiles with the same width across their flats tapers in the direction of its center. In particular, the outer edges of the connecting crosspiece here have a curved progression, in particular an essentially parabolic progression, wherein the center of the connecting crosspiece forms the vertex. It has been found that, while loading capability of the first connectors is high, this allows weight to be reduced further.

In contrast, for a connecting crosspiece of a respective first connector which connects to one another two octagonal profiles with different widths across their flats, provision is made in particular for the connecting crosspiece to taper in the direction of the octagonal profile with the smaller width across its flats. The connecting crosspiece can then, in particular in plan view, have a trapezoidal contour, which has proven to be advantageous in respect of weight and loading capability.

In the case of a further advantageous configuration, a connecting crosspiece of a respective first connector is connected to the inner portions via a continuously formed-on portion. This gives rise to a particularly advantageous flow of forces during loading, as result of which the overall loading capability is advantageously increased further.

In particular, provision is additionally made for at least some of the first connectors each to be designed in the form of pressure die castings. The connecting crosspiece and the different portions are therefore advantageously not welded to one another. This advantageously simplifies the construction further. In particular, provision is made for those first connectors which connect the octagonal profiles to form the basic carrying structure to be designed in the form of pressure die castings. Rendering the connectors in the form of pressure die castings advantageously means that the latter are homogeneous components and are therefore of low-stress and strength-optimized design. In particular, provision can also be made for at least some of the first connectors to be produced by additive manufacturing. The material provided for the first connectors is in particular aluminum. According to an advantageous variant, the material provided for the first connectors is steel.

According to a further configuration of the carrying system, provision is made for the clearances of the inner portions of the arrangement portions of the first connectors to be dimensioned in such a manner that, in order for the first connectors to be mounted on the octagonal profiles, the first connectors can be centered via centering pins introduced into the clearances. This advantageously simplifies the construction of the carrying system further. For this purpose, the centering pins are advantageously introduced into the corresponding arrangement holes in an octagonal profile on which the connector is to be arranged. The centering pins here advantageously project through the clearance, wherein, when the first connector is arranged correctly, an inner boundary of the clearance advantageously serves as a stop in the direction of the connecting location of the arrangement portions. In particular, provision is made for a centering pin, for assembly or mounting purposes, to be inserted through the clearance from the inside in each case. Provision is also made in particular for it to be possible for the centering pins to be introduced into the profile in part through the connector, in particular to be introduced into the profile in a form-fitting and/or force-fitting manner. A further significant assembly-related or mounting-related advantage can be realized as a result. In addition, it is also advantageously possible for connectors to be put in place retrospectively with the aid of the centering pins, without the carrying structure being dismantled.

Provision is also advantageously made for the first connectors which connect to one another two octagonal profiles with the same widths across their flats to be arranged on the respective octagonal profile via in each case three fastening holes, arranged directly one after the other in the respective outer portions, by way of bolts, in particular threaded bolts, which engage in the arrangement holes. Overall, twelve bolts are therefore used to arrange a thus configured first connector on the two octagonal profiles which are connected to one another by the first connector. This advantageously achieves a very high loading capability.

In contrast, for first connectors which connect to one another two octagonal profiles with different widths across their flats, provision is made in particular for the arrangement portion which is arranged on the octagonal profile with the greater width across its flats to extend over four arrangement holes in the octagonal profile, wherein this first connector is arranged on the octagonal profile with the greater width across its flats via in each case three fastening holes, arranged in the respective outer portions, by way of bolts, in particular threaded bolts, which engage in the arrangement holes, wherein, starting from the connecting location of the octagonal profiles, the fastening holes coincide with the first two arrangement holes and the fourth arrangement hole. In the case of the octagonal profile with the smaller width across its flats, in contrast, the arrangement preferably takes place via the first three arrangement holes.

A further advantageous configuration makes provision for the arrangement portions of the second connectors to be arranged spaced apart from one another via a connecting structure, in particular, as seen in respect of a common perpendicular bisector, to be arranged orthogonally in relation to one another. The arrangement portions of the second connectors here advantageously have continuous second outer portions, which butt in a form-fitting manner against the outer side surfaces of the adjacent side surfaces and comprise second fastening holes, which are designed in particular to correspond to the arrangement holes. The second outer portions are advantageously connected to one another via the connecting structure. There is advantageously a clearance, in particular an essentially rectangular clearance with preferably rounded corners, between the second outer portions of a respective arrangement portion. In particular, provision is made for the clearance to take up in each case 40% to 90% of the surface area of a respective inner portion, furthermore in particular 70% to 80% of the surface area of a respective inner portion. By virtue of this clearance, the second connectors are advantageously of low weight.

The connecting structure also advantageously has ribs, which connect the second outer portions of a respective arrangement portion. These ribs advantageously further increase the loading capability and provide a further reduction in weight. The ribs advantageously each extend between a longitudinal side and an end side of the adjacent second outer portions. Each connecting structure, then, comprises respectively four rib arrangements. In particular, provision is made for a rib arrangement to comprise respectively four ribs.

According to an advantageous development, there is a clearance between the inner ribs of the connecting structure. This advantageously further reduces the weight of the second connectors. There can also be a clearance provided between the outer ribs. There is preferably a recess between the outer ribs, the recess having a connecting surface which connects the outer ribs.

As a result, while the connector is of low weight, this provides improved support for the respective outer ribs, which results in further-improved loading capability. In particular, provision is also made for the outer ribs to be of curved design. The inner ribs are advantageously of rectilinear design. This advantageously further improves the loading capability.

In particular, provision is additionally made for at least some of the second connectors to be designed in the form of pressure die castings. The connecting structure with the ribs and the different portions are therefore advantageously not welded to one another. This advantageously further simplifies the construction. In addition, rendering the connectors in the form of pressure die castings advantageously means that the latter are homogeneous components and are therefore of low-stress and strength-optimized design. According to an advantageous variant, at least some of the second connectors are produced by additive manufacturing. The material provided for the second connectors is in particular aluminum. As an advantageous variant, the material provided for the second connectors is steel.

A further advantageous configuration of the carrying system makes provision for at least some of the connecting elements each to have at least one centering pin, in particular two centering pins, wherein the at least one centering pin engages in an arrangement hole in the respective octagonal profile, this preferably being designed in the form of a direct thread. The connecting elements designed in this way are thus advantageously positioned in the longitudinal direction of the octagonal profiles.

The connecting elements of the carrying system, in particular all the connecting elements of the carrying system, are advantageously either pressure die castings or precision castings or are components produced by additive manufacturing, in particular components produced by 3D printing.

According to a further advantageous aspect, at least some of the octagonal profiles of the carrying system, in particular all the octagonal profiles, are made of aluminum. The octagonal profiles here preferably each have a material accumulation in the interior, beneath the side surfaces. The arrangement holes advantageously pass through the respective material accumulation. This advantageously makes it possible, without increasing the overall wall thickness of the octagonal profiles, to introduce internal threads into the arrangement holes. Accordingly, provision is made in particular for the arrangement holes to have an internal thread. This advantageously does away with the use of blind-rivet nuts, the construction being further simplified as a result.

In contrast, according to an alternative particularly advantageous configuration, provision is made for at least some of the octagonal profiles, in particular all the octagonal profiles, furthermore in particular the octagonal profiles which form the basic carrying structure, to be formed from a steel sheet. The steel sheet is then advantageously appropriately folded to form the octagonal profile, wherein the ends of the steel sheet are welded to one another. Using steel as the material for the octagonal profiles is also made possible in particular by the carrying-system connecting elements allowing relatively high tolerances. The relatively high tolerances of the connecting elements result in particular from the fact that these butt prismatically only against two surfaces. The octagonal profiles made of steel can advantageously be subjected to pronounced loading and, with a loading capability comparable to octagonal profiles made of aluminum, have a relatively low weight. In addition, using steel instead of aluminum achieves a reduced carbon footprint. In the case of octagonal profiles made of sheet steel, provision is made in particular for blind-rivet nuts to be introduced into the arrangement holes, the connecting elements being thereby screw-connected as a result. In particular, the steel sheet has a thickness between 1 mm and 20 mm. According to an advantageous variant, the steel sheet has a material accumulation in the region of the arrangement holes, and so the steel sheet is thicker there, wherein a thread is advantageously introduced, in particular cut, into the arrangement holes. Assembly of the carrying system is advantageously further simplified if a thread is introduced into the arrangement holes. In particular, the octagonal profiles are designed in the form of rolled profiles.

Further advantageous details, features and specifics of the invention will be explained in more detail in combination with the exemplary embodiments illustrated in the figures (Fig.: figure), in which:

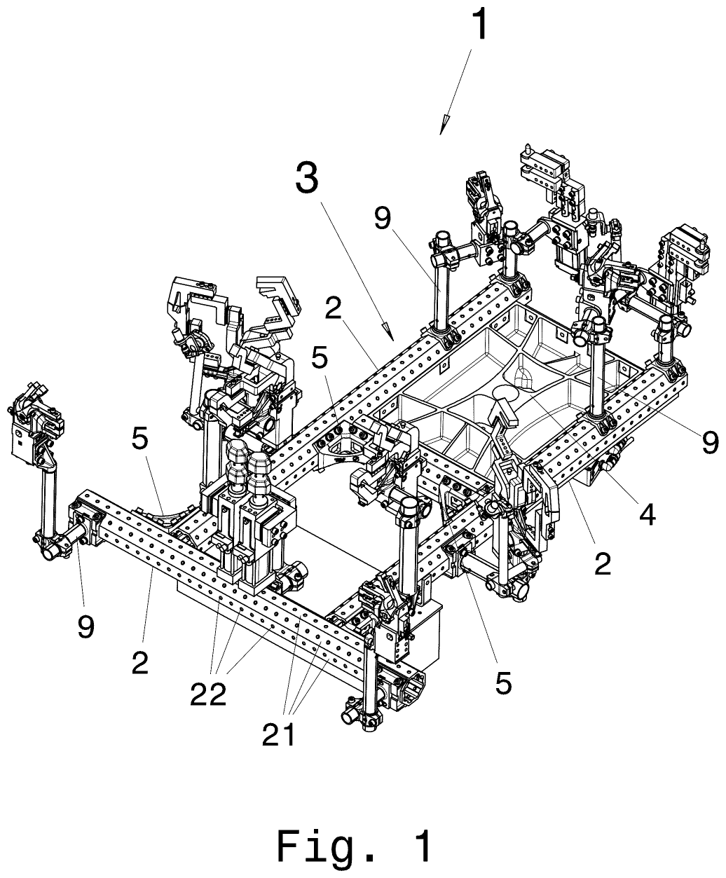

FIG. 1 shows a perspective illustration, as seen obliquely from above, of an exemplary embodiment of a carrying system designed according to the invention;

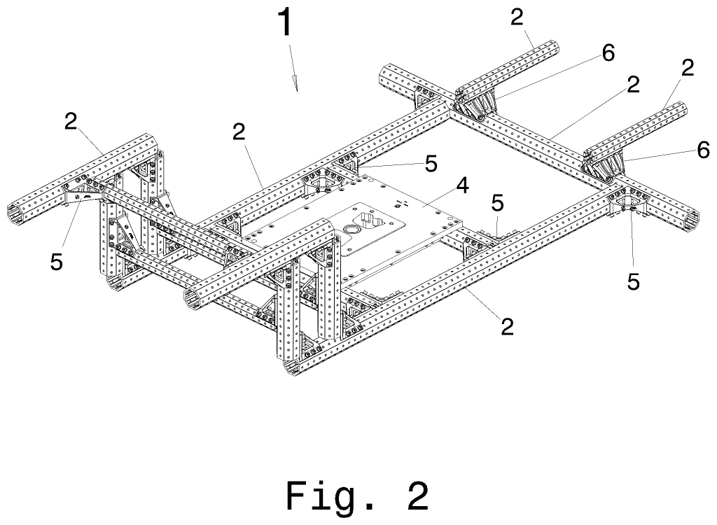

FIG. 2 shows a perspective illustration of a further exemplary embodiment of a carrying system designed according to the invention;

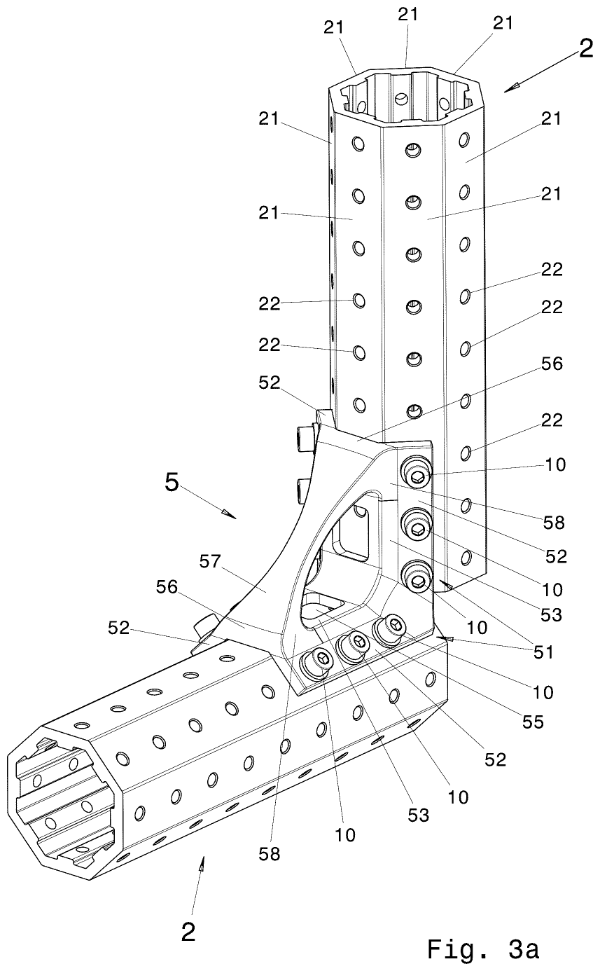

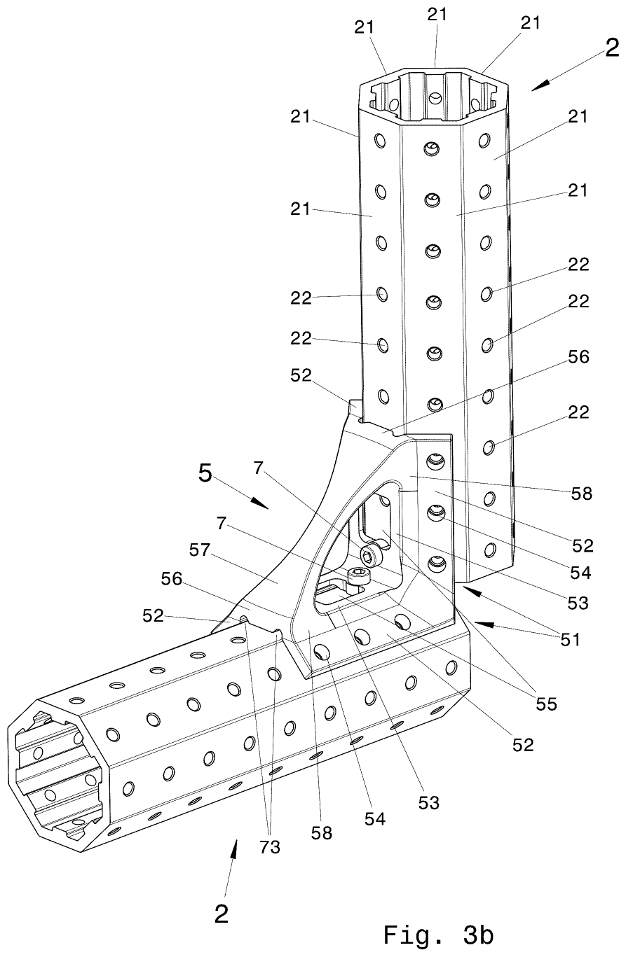

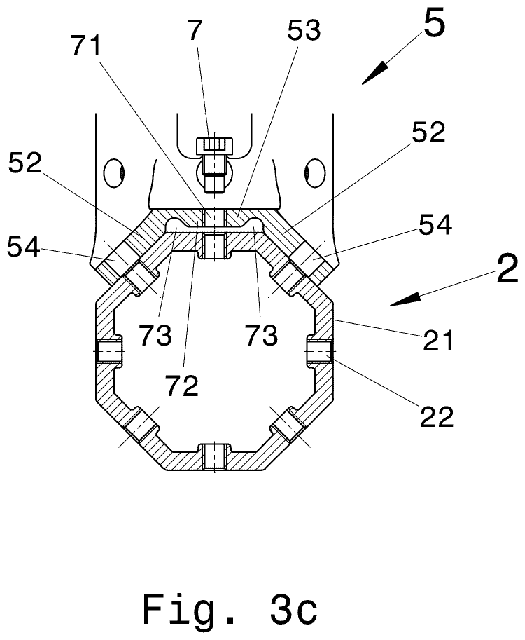

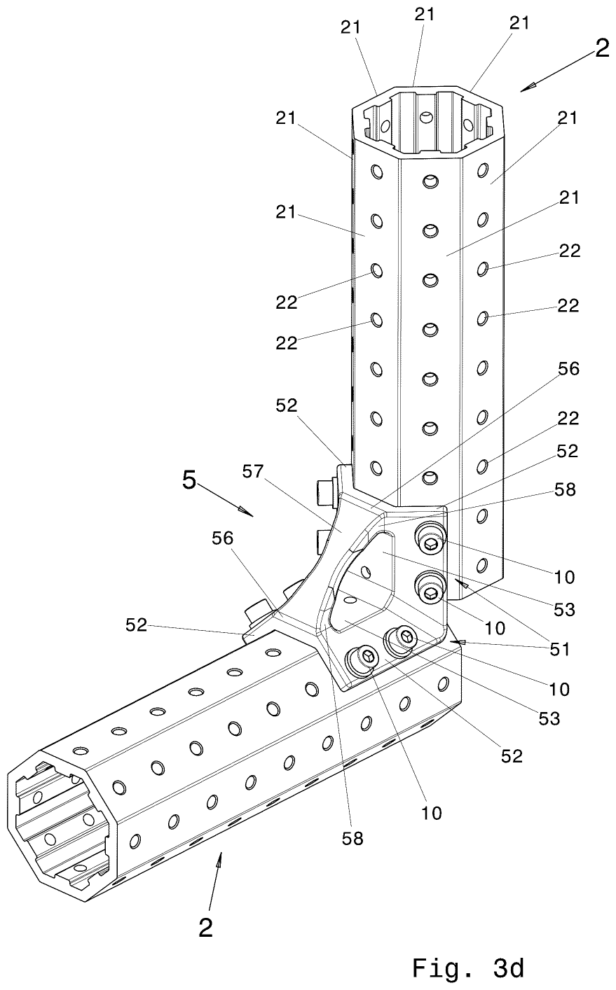

FIG. 3a shows a perspective illustration of an exemplary embodiment of a first connector which belongs to a carrying system designed according to the invention and connects to one another two octagonal profiles with the same width across their flats;

FIG. 3b shows a perspective illustration of a further exemplary embodiment of a first connector which belongs to a carrying system designed according to the invention and connects to one another two octagonal profiles with the same width across their flats;

FIG. 3c shows a sectional illustration of the first connector according to the exemplary embodiment shown in FIG. 3b attached to an octagonal profile;

FIG. 3d shows a perspective illustration of a further exemplary embodiment of a first connector which belongs to a carrying system designed according to the invention and connects to one another two octagonal profiles with the same width across their flats;

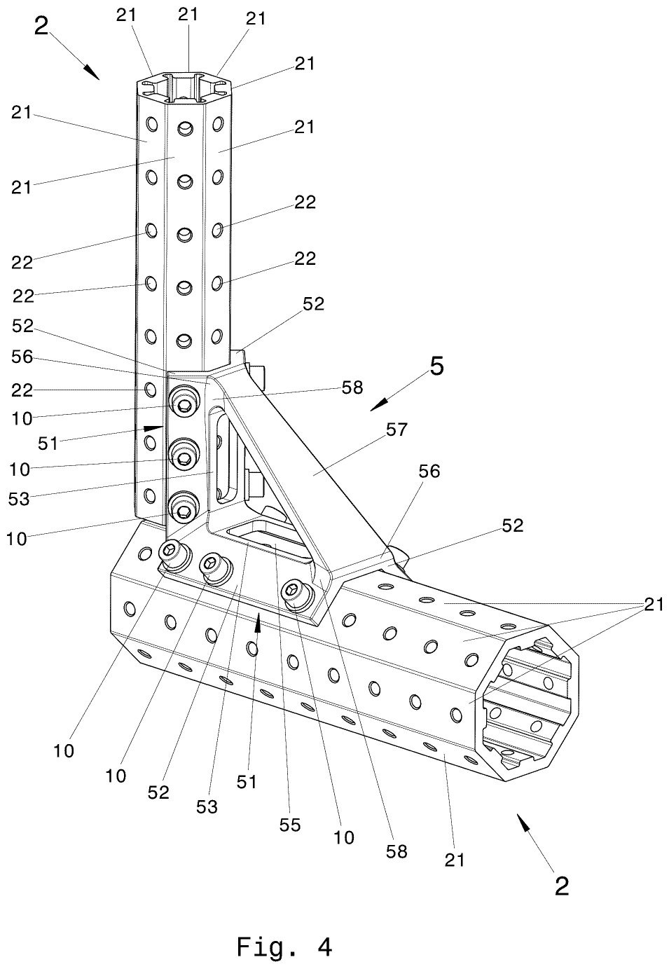

FIG. 4 shows a perspective illustration of an exemplary embodiment of a first connector which belongs to a carrying system designed according to the invention and connects to one another two octagonal profiles with different widths across their flats;

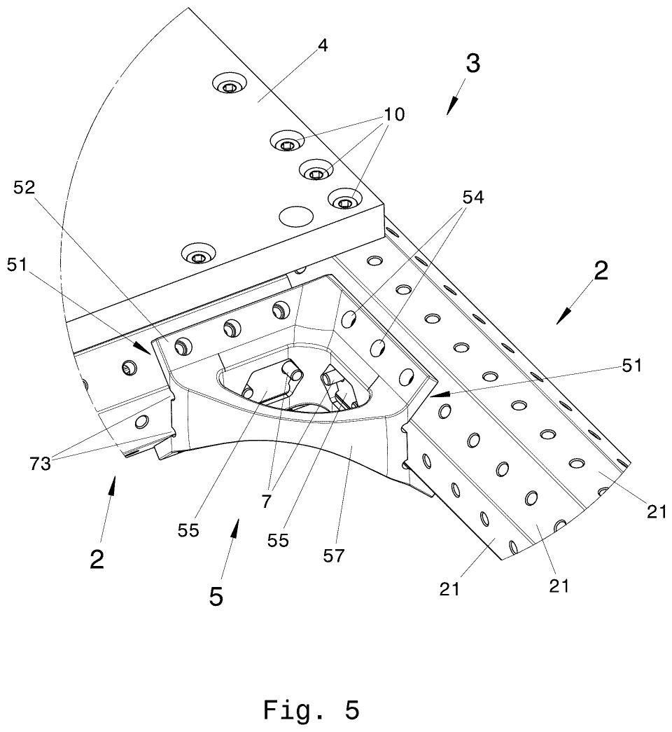

FIG. 5 shows a perspective illustration of a further exemplary embodiment of a first connector which belongs to a carrying system designed according to the invention and is intended to be connected to two octagonal profiles with the same width across their flats;

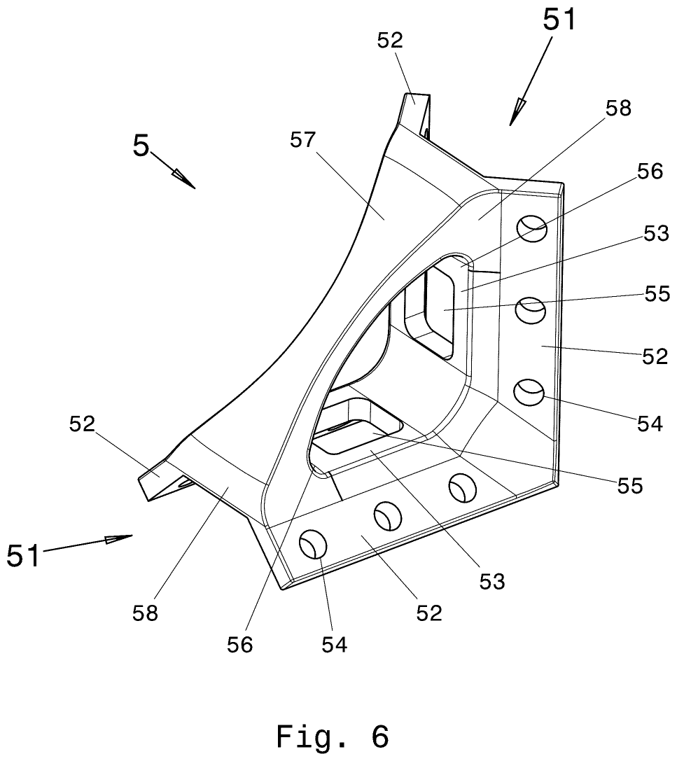

FIG. 6 shows a perspective illustration of a further exemplary embodiment of a first connector of a carrying system designed according to the invention;

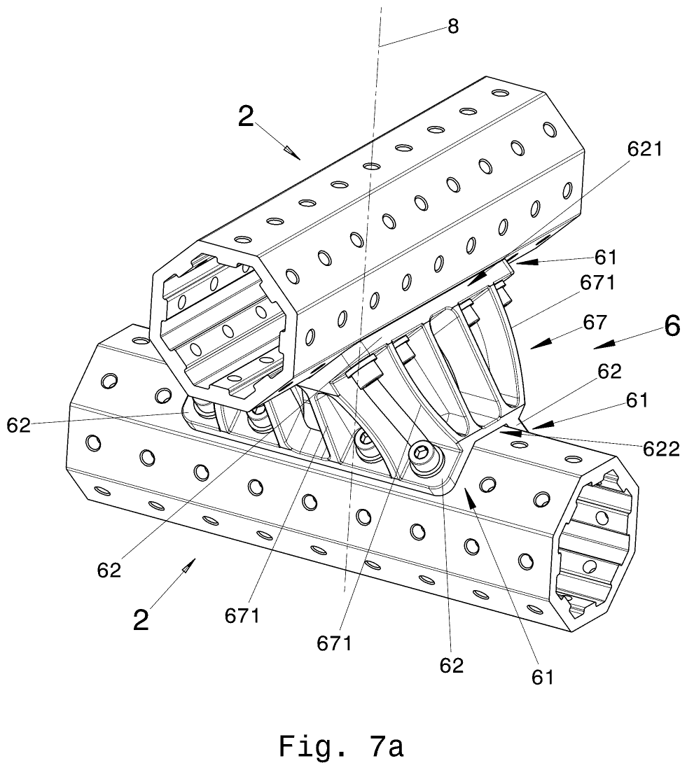

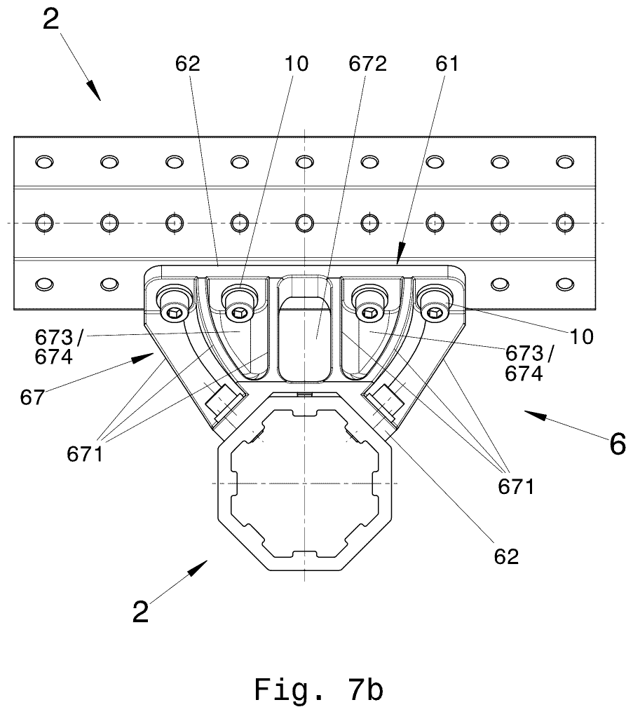

FIG. 7a shows a perspective illustration of an exemplary embodiment of a second connector which belongs to a carrying system designed according to the invention and connects to one another two octagonal profiles with the same width across their flats;

FIG. 7b shows a side view of the exemplary embodiment according to FIG. 7a;

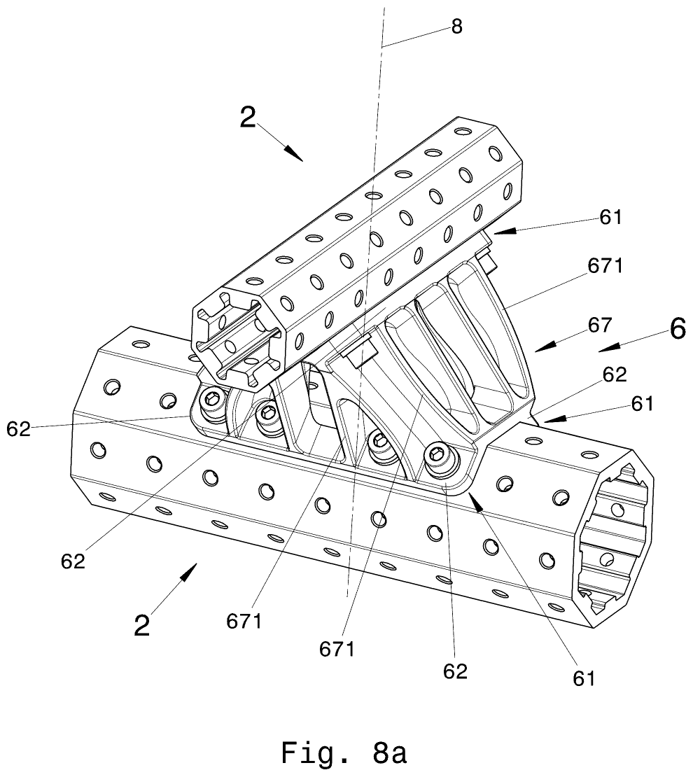

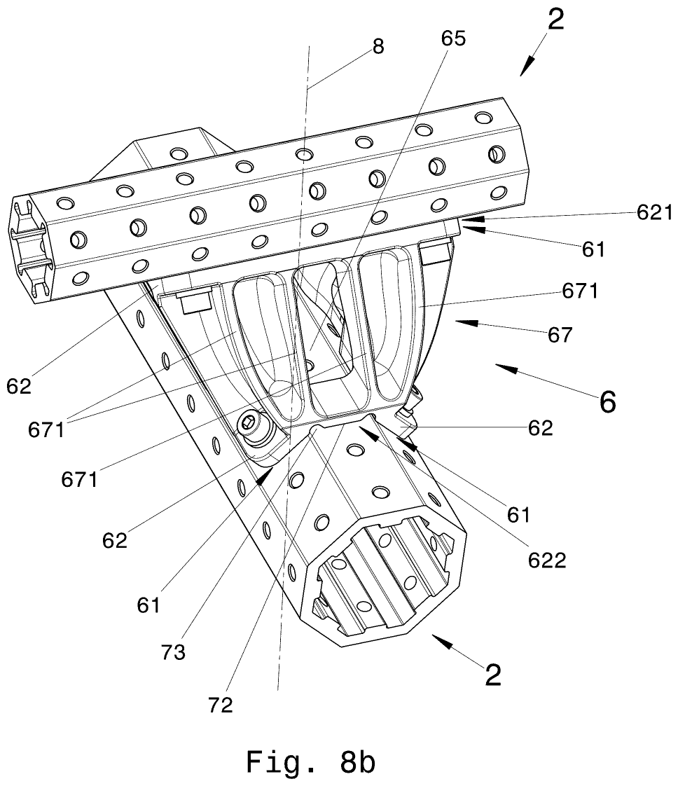

FIG. 8a shows a perspective illustration of an exemplary embodiment of a second connector which belongs to a carrying system designed according to the invention and connects to one another two octagonal profiles with different widths across their flats;

FIG. 8b shows a perspective illustration of a further exemplary embodiment of a second connector which belongs to a carrying system designed according to the invention and connects to one another two octagonal profiles with different widths across their flats;

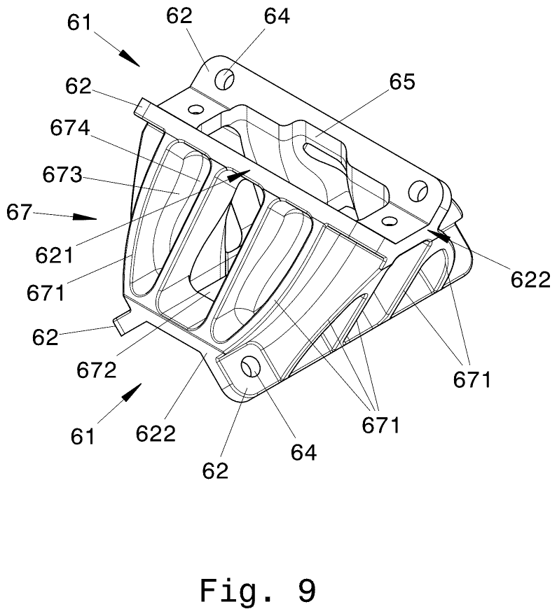

FIG. 9 shows a perspective illustration of a further exemplary embodiment of a second connector of a carrying system designed according to the invention;

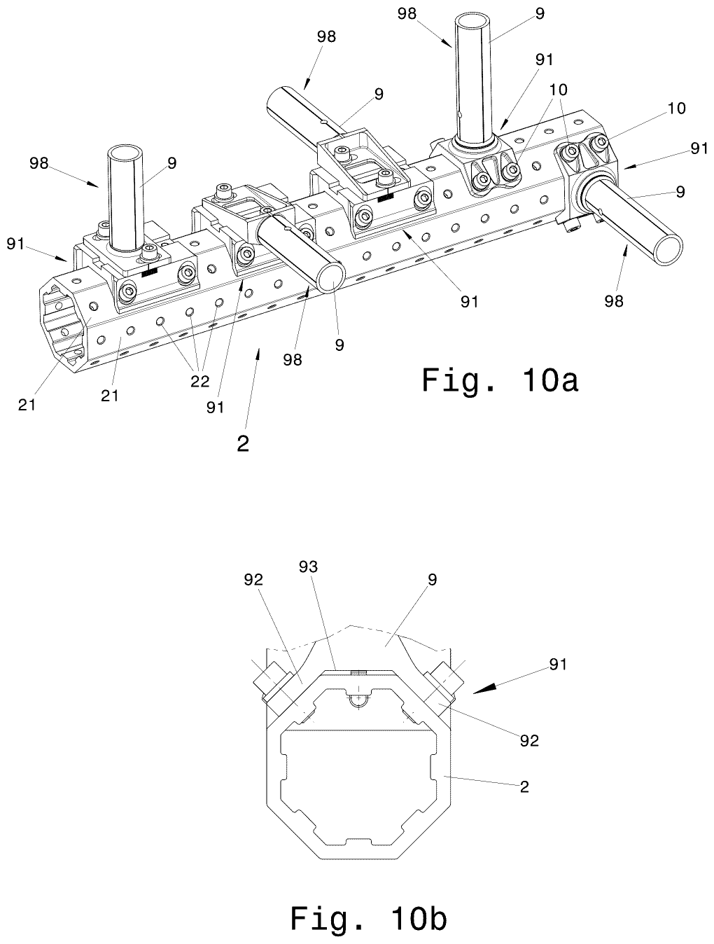

FIG. 10a shows a perspective illustration of a further exemplary embodiment of an octagonal profile with, arranged on it, further connecting elements of a carrying system designed according to the invention;

FIG. 10b shows a front view of a further exemplary embodiment of an octagonal profile with, arranged on it, further connecting elements of a carrying system designed according to the invention;

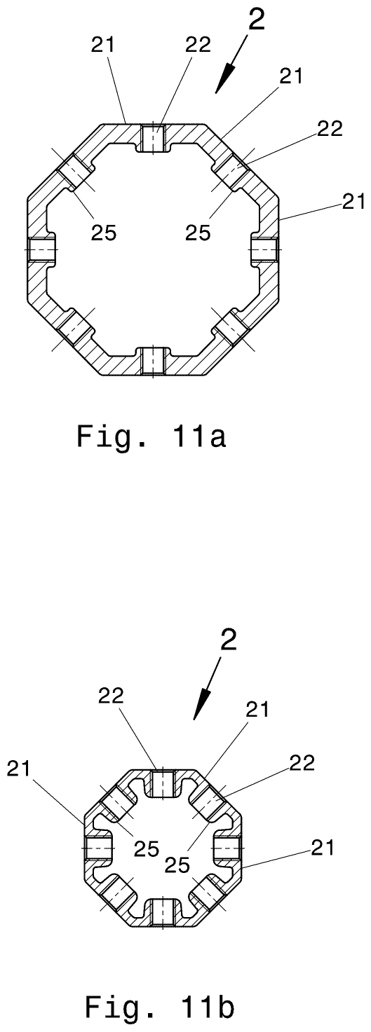

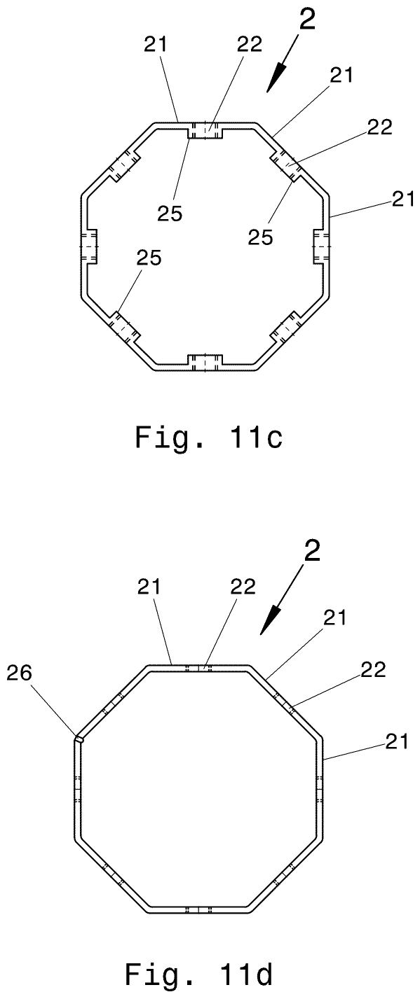

FIG. 11a shows a sectional illustration of an exemplary embodiment of an aluminum octagonal profile which belongs to a carrying system designed according to the invention and has a first width across its flats;

FIG. 11b shows a sectional illustration of a further exemplary embodiment of an aluminum octagonal profile which belongs to a carrying system designed according to the invention and has a second width across its flats;

FIG. 11c shows a sectional illustration of an exemplary embodiment of a steel octagonal profile of a carrying system designed according to the invention;

FIG. 11d shows a sectional illustration of a further exemplary embodiment of a steel octagonal profile of a carrying system designed according to the invention;

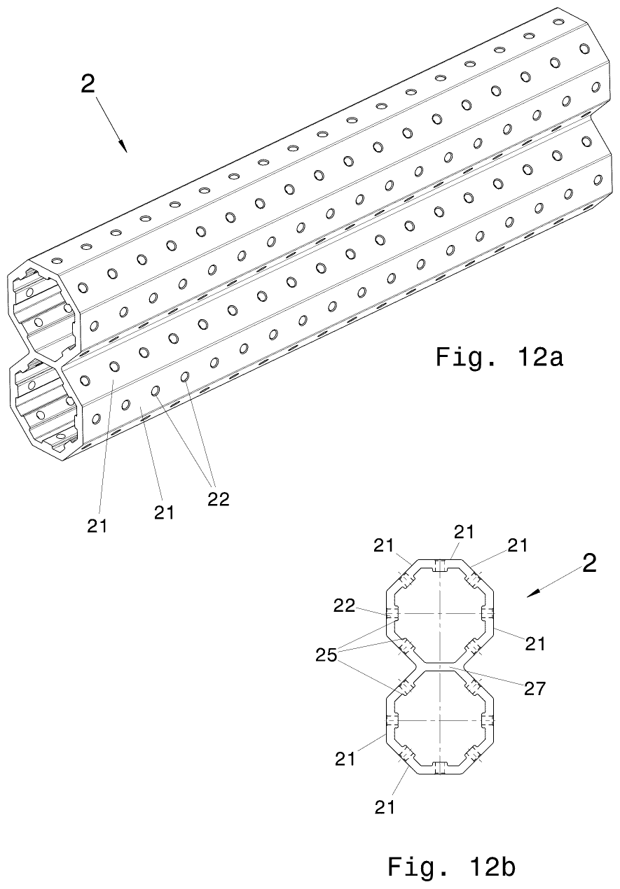

FIG. 12a shows a perspective illustration of a further exemplary embodiment of an octagonal profile of a carrying system designed according to the invention; and

FIG. 12b shows a sectional illustration of the octagonal profile according to the exemplary embodiment shown in FIG. 12a.

Like parts are generally provided with like reference signs in the various figures and are therefore sometimes also each explained only in combination with one of the figures.

FIG. 1 illustrates a perspective view of an exemplary embodiment of a carrying system 1 designed according to the invention, the illustration being tilted toward the person viewing it. The carrying system 1 is of modular construction and, in this exemplary embodiment, is designed for carrying workpieces so that they can be worked on. The carrying system 1 comprises four octagonal profiles 2 each with eight side surfaces 21, which each have a multiplicity of arrangement holes 22. The octagonal profiles 2 here can be made of aluminum, preferably of steel. The octagonal profiles 2 of the carrying system 1 are connected to one another via connecting elements 5 to form a basic carrying structure 3. In this exemplary embodiment, a gripper-attachment plate is arranged, in the form of a main body 4, on the basic carrying structure 3. As illustrated in FIG. 1, also arranged on the octagonal profiles 2 are a plurality of connecting elements 9 which have further functional elements, in particular collet chucks for receiving vehicle-body components. Details relating to the configuration of the carrying system 1 and/or to components of the carrying system 1 will be explained further hereinbelow with reference to the rest of the figures.

FIG. 2 shows a further exemplary embodiment of a carrying system 1 designed according to the invention, this one comprising a greater number of octagonal profiles 2 than the carrying system 1 shown in FIG. 1 and having octagonal profiles 2 with different widths across their flats. It is also the case with the carrying system 1 shown in FIG. 2 that a plurality of octagonal profiles 2 are connected to one another via a plurality of first connectors 5 to form a basic carrying structure 3. A main-body plate 4 is also arranged here on the basic carrying structure 3. Also arranged on the basic carrying structure 3 via first connectors 5 are further octagonal profiles 2 which in particular make it possible for further functional elements and/or connecting elements which perform further functions to be arranged on the basic carrying structure. This makes it possible to construct modular carrying systems on an individual basis. The connecting elements which are essential for this purpose will be described hereinbelow with reference, in particular the first connectors 5 and the second connectors 6 of a carrying system 1 designed according to the invention.

FIG. 3a to FIG. 3d illustrate possible exemplary embodiments of the configuration of a first connector 5 which connects at right angles to one another two octagonal profiles 2 which are arranged in the same arrangement plane and have the same width across their flats. A first connector 5 which, according to FIG. 3a, connects two octagonal profiles 2 to one another is also shown on its own in FIG. 6. The first connectors 5 shown are provided in particular for use in a carrying system 1 as shown in particular in FIG. 1 and FIG. 2.

The first connectors 5 each have two arrangement portions 51, which each engage around three adjacent side surfaces 21 of an octagonal profile 2. The first connectors 5 connect two octagonal profiles 2 in such a manner that the arrangement portions 51 are each spaced apart from the central side surface of the three adjacent side surfaces 21 of a respective octagonal profile 2. In addition, the arrangement portions 51 are arranged in a form-fitting manner on the outer side surfaces of the three adjacent side surfaces 21 of a respective octagonal profile 2.

The arrangement portions 51 of the first connectors 5 are arranged at right angles in relation to one another in order to make it possible for the octagonal profiles 2 to be connected to one another in such a manner that they are arranged at right angles in relation to one another. Each of the two arrangement portions 51 comprises in each case two continuous outer portions 52, which butt in a form-fitting manner against the outer side surfaces of the three adjacent side surfaces 21 of the octagonal profiles 2, and an inner portion 53, which connects the two first outer portions 52. The first outer portions 52 of the first connectors 5 have fastening holes 54, which are designed to correspond to the arrangement holes 22 of the octagonal profiles 2. In the case of the exemplary embodiments shown in FIG. 3a to FIG. 3c, the respective inner portion 53 also has a clearance 55. The inner portion 53 of the first connector 5 shown in FIG. 3d has no such clearance, in particular because in the exemplary embodiment the octagonal profiles 2 have a smaller width across their flats than in the exemplary embodiment shown in FIG. 3a. It is also the case that the first connector according to FIG. 3d is arranged on the octagonal profiles 2 only by way of a total of eight screws 10.

In the exemplary embodiment shown in FIG. 3a to FIG. 3d, provision is made for a respective thread to be introduced into the arrangement holes 22, wherein the first connectors 5 are arranged on the two non-abutting side surfaces 21 of the octagonal profile 2 by means of screws 10. The screws 10 here pass through the fastening holes 54 and are screwed to the threads of the arrangement holes 22. The inner portions 53 here are not in contact with the central side surface of the three adjacent side surfaces 21, but rather are spaced apart in each case from the central side surface 21, as can also be seen in particular from FIG. 3c. In the exemplary embodiment shown in FIG. 3a, the first connector is arranged on the octagonal profiles 2 via a total of twelve screws 10.

For simplified construction and dismantling of a carrying system 1, the respective clearance 55 of the inner portions 53 for a first connector 5, as shown in FIG. 3a, is dimensioned in such a manner that, in order for the first connectors 5 to be mounted on the octagonal profiles 2, the first connectors 5 can be centered via centering pins 7 introduced through the clearances 55 and into the arrangement holes 22, as shown by way of example in FIG. 5. In particular rough positioning of the first connector 5 on the respective octagonal profile 2 can be achieved, then, by means of the centering pins 7.

On the other hand, in the case of the variant of a first connector 5 shown in FIG. 3b and FIG. 3c, and in the case of the variant shown in FIG. 3d, provision is made, in contrast with the exemplary embodiment shown in FIG. 3a, for the first connector 5 to comprise a centering hole 71 specifically in the respective inner portion 53, it being possible for a centering pin 7 to be guided through the centering hole for simplified assembly and dismantling of a carrying system 1. In the region of the centering hole 71, the inner portions 53 in the case of the exemplary embodiment shown in FIG. 3b and FIG. 3c, and also in the case of the exemplary embodiment shown in FIG. 3d, each have a material accumulation 72 and, in the transition to the outer portions 52, a material clearance 73. This advantageously further improves cable guidance and/or line guidance in the region between the central side surface 21 and inner portion 53. It is also the case that weight of the first connector 5 can be thereby reduced in addition.

The centering hole 71 allows in particular further-improved positioning of the first connector on the respective octagonal profile 2. In particular, it is possible for the first connectors 5 to be positioned lengthwise at specific unit spacings on a respective octagonal profile 2 when a carrying system 1 is being constructed. The centering pins 7 advantageously also make it possible for a carrying system 1 to be supplemented by further octagonal profiles 2 without existing structures having to be first dismantled.

In the exemplary embodiments, it is also the case that the first connectors 5 have a connecting crosspiece 57, which connects the outer ends 56 of the inner portions 53 and tapers in the direction of its center. The connecting crosspiece 57 here has each of its ends connected to the inner portions 53 via a continuous formed-on portion 58. The configuration of the first connectors 5 here follows the bionics, wherein the specific configuration of the first connectors 5 provides the same with a very high level of rigidity, while being of low weight, and, even in the case of high loading, the levels of stressing which occur are considerably lower in comparison with connecting elements which comprise purely regular geometries. Such a configuration is made possible in particular by the first connectors 5 being manufactured in the form of a pressure die casting.

FIG. 4 shows an exemplary embodiment of a first connector 5 by means of which, in contrast to the configurations shown in FIG. 3a to FIG. 3c, two octagonal profiles 2 with different widths across their flats are connected to one another at right angles in the same arrangement plane. For this purpose, some of the features of the first connector 5 are configured differently to those of the first connector 5 described above. In particular, the arrangement portion 51 by way of which the first connector 5 is arranged on the octagonal profile 2 with the smaller width across its flats is narrower than the arrangement portion 51 by way of which the first connector 5 is arranged on the octagonal profile 2 with the greater width across its flats. In addition, the arrangement portion 51 arranged on the octagonal profile 2 with the greater width across its flats here extends over four arrangement holes 22 of the octagonal profile 2, wherein the respective outer portions 52, as shown in FIG. 4, have three fastening holes 54. In the case of the octagonal profile 2 with the smaller width across its flats, in contrast, the arrangement takes place via the first three arrangement holes 22 and correspondingly designed fastening holes 54. In addition, the connecting crosspiece 57 of this first connector 5 tapers in the direction of the octagonal profile 2 with the smaller width across its flats. The connecting crosspiece 57 here has, in plan view, a trapezoidal contour, as shown in FIG. 4.

FIG. 7a and FIG. 7b show an exemplary embodiment of the configuration of a second connector 6, in particular for use in a carrying system 1 as shown in FIG. 2. By means of the second connector 6, two octagonal profiles 2 with the same width across their flats are connected to one another at right angles in arrangement planes which are offset parallel in relation to one another, FIG. 7a showing a perspective illustration and FIG. 7b showing a side view. FIG. 9 shows a perspective illustration of the second connector 6 on its own. FIG. 8a and FIG. 8b show further exemplary embodiments of the configuration of a second connector 6, this time designed in each case for the right-angled connection of two octagonal profiles 2 with different widths across their flats in arrangement planes which are offset parallel in relation to one another.

The second connector 6, like the first connector 5, has in each case two arrangement portions 61, which each engage around three adjacent side surfaces 21 of an octagonal profile 2. The second connector 6 here connects in each case two octagonal profiles 2 in such a manner that the arrangement portions 61 are each spaced apart from the central side surface of the three adjacent side surfaces 21 of a respective octagonal profile 2, in particular as shown in FIG. 7b. In addition, the second connector 6 is arranged in a form-fitting manner, by means of the arrangement portions 61, on the outer side surface of the three adjacent side surfaces 21 of a respective octagonal profile 2 via the arrangement holes 22 in the outer side surface of the three adjacent side surfaces 21. The arrangement portions 61 of the second connector 6 are spaced apart from one another via a connecting structure 67 and, as seen in respect of a common perpendicular bisector 8, are arranged orthogonally in relation to one another. In addition, the arrangement portions 61 of the second connector 6 have continuous second outer portions 62, which butt in a form-fitting manner against the outer side surfaces of the three adjacent side surfaces 21 and have second fastening holes 64, which are designed to correspond to the arrangement holes 22 of the octagonal profiles 2. These second outer portions 62 are connected to one another here via the connecting structure 67, wherein there is a clearance 65 between the second outer portions 62 of a respective arrangement portion 61 of the second connector 6, in particular as shown in FIG. 9.

The connecting structure 67 of the second connector 6 has a plurality of ribs 671, which connect the second outer portions 62 of a respective arrangement portion 61. The ribs 671 each extend between a longitudinal side 621 and an end side 622 of the spaced-apart second outer portions 62. A first number of ribs 671—in the exemplary embodiments shown four ribs 671—run from a first outer portion 62 of a first arrangement portion 61 to a first outer portion 62 of a second arrangement portion 61 of the second connector 6. The same number of ribs 671—in the exemplary embodiments shown four ribs 671—run from a second outer portion 62 of the first arrangement portion 61 to a second outer portion 62 of the second arrangement portion 61 of the second connector 6.

In the exemplary embodiments shown in FIG. 7a to FIG. 9, the second connectors 6 have a clearance 672 between the two inner ribs 671. This means that there is no material present between the inner ribs 672. The second connectors 6 each have a recess 673 between a respective outer rib 671 and the adjacent inner rib 671, the recess having a connecting surface 674 which connects the outer ribs 671. In contrast to the clearance, the connecting surface 674 in these exemplary embodiments means that there is still material present between the outer and the inner rib 671. It is also the case that, in the exemplary embodiments shown, the outer ribs 671 are of curved design and the inner ribs 671 are of rectilinear design. Like the configuration of the first connectors 5, the configuration of the second connectors 6 here follows the bionics, wherein it is also the case that the specific configuration of the second connectors 6 provides the same with a very high level of rigidity, while being of low weight, and, even in the case of high loading, the levels of stressing which occur are considerably lower in comparison with connecting elements which comprise purely regular geometries. Such a configuration is made possible in particular by the second connectors 6 being manufactured in the form of a pressure die casting.

As is also the case for the variants of a first connector 5 shown in FIG. 3b to FIG. 3d, a second connector can also comprise a centering hole 71, it being possible for a centering pin 7 to be guided through the centering hole for simplified assembly and dismantling of a carrying system 1, this not being shown explicitly in the figures for the second connector 6. As shown by way of example in FIG. 8b, it is likewise possible for the second connector 6, like the first connectors 5 shown in FIG. 3b to FIG. 3d, to have in the central region of an arrangement portion 61, which is spaced apart from the central side surface of the three side surfaces 21 of an octagonal profile which are enclosed by the arrangement portion 61, a respective groove-like material clearance 73 at the transition to the outer portions 62. This advantageously further improves cable guidance and/or line guidance in the region between the central side surface 21 and central region of an arrangement portion 61. It is also the case that weight of the second connector 6 can be thereby reduced in addition.

FIG. 10a shows an octagonal profile 2 with in each case eight side surfaces 21, which each have a multiplicity of arrangement holes 22, wherein a multiplicity of possible configurations of connecting elements 9 performing extended functions are evident on the octagonal profile 2. It is also the case that these connecting elements 9 each have an arrangement portion 91, which engages around in each case three adjacent side surfaces 21 of the octagonal profile 2, wherein the arrangement portions 91 are each spaced apart, by means of an inner portion 93, from the central side surface of the three adjacent side surfaces 21 of a respective octagonal profile 2, as illustrated by way of example in FIG. 10b, and are arranged in a form-fitting manner, by means of the outer portions 92, on the outer side surfaces of the three adjacent side surfaces 21 of a respective octagonal profile 2 via the arrangement holes 22 of the outer side surfaces of the three adjacent side surfaces 21. These further connecting elements 9 each have a functional portion 98, which performs the further function or via which the further function can be performed, in particular by a tool being arranged on the functional portion 98.

FIG. 11a and FIG. 11b illustrate two configurations of aluminum octagonal profiles 2 with different widths across their flats for use in a carrying system 1, as shown in FIG. 1 and FIG. 2. The octagonal profile 2 which is shown in FIG. 11a has a greater width across its flats than the octagonal profile 2 shown in FIG. 11b. Beneath the side surfaces 21, the octagonal profiles 2 each have a material accumulation 25, through which the arrangement holes 22 pass. The material accumulations 25 here make it possible for threads to be introduced into the arrangement holes 22. Accordingly, the arrangement holes 22 have an internal thread, as a result of which there is no need for any blind-rivet nuts, which simplifies the assembly of the carrying system 1.

FIG. 11c shows a variant of an octagonal profile 2, this time made of steel, which has the same width across its flats as the exemplary embodiment shown in FIG. 11a. It can clearly be seen from the comparison of FIG. 11a and FIG. 11c that the octagonal profile 2 made of steel has a significantly smaller wall thickness than the octagonal profile 2 made of aluminum. However, the octagonal profile 2 shown in FIG. 11c is more advantageous in respect of strength and rigidity than the configuration made of aluminum. It is also the case that, beneath the side surfaces 21, the steel octagonal profile 2 shown in FIG. 11c has a respective material accumulation 25, through which the arrangement holes 22 pass. Here too, the material accumulations 25 make it possible for threads to be introduced into the arrangement holes 22. Accordingly, the arrangement holes 22 have an internal thread, as a result of which there is no need for any blind-rivet nuts, which simplifies the assembly of the carrying system 1.

FIG. 11d shows a further variant of an octagonal profile 2 made of steel. The octagonal profile 2 here is formed from a steel sheet, in particular a rolled steel sheet, which has been angled appropriately. The ends of the steel sheet here are welded to one another, a weld seam 26 being shown by way of example in FIG. 11d.

FIG. 12a shows a perspective illustration of a double octagonal profile 2 forming an octagonal profile for a carrying system 1 in particular as illustrated in FIG. 2. In addition, FIG. 12b shows a sectional illustration of this double octagonal profile 2. While ensuring the same attachment capability for connecting elements 4, 6, 9, the configuration of the double octagonal profile 2 advantageously provides for strengthening, in particular where long lengths are involved. The double octagonal profile 2 is configured, in principle, in the manner of two previously described octagonal profiles 2 with a common connecting side 27 replacing one side surface 21.

The exemplary embodiments which are illustrated in the figures and have been explained in combination therewith serve to explain the invention and do not limit the invention.

### LIST OF REFERENCE SIGNS

1 carrying system
2 octagonal profile
21 side surface
22 arrangement hole
25 material accumulation
26 weld seam
27 connecting side
3 basic carrying structure
4 main body
5 first connector
51 arrangement portion
52 outer portion
53 inner portion
54 fastening hole
55 clearance
56 outer end of an inner portion (53)
57 connecting crosspiece
58 continuous formed-on portion
6 second connector
61 arrangement portion
62 outer portion
621 longitudinal side
622 end side
64 fastening hole
65 clearance
67 connecting structure
671 rib
672 clearance
673 recess
674 connecting surface
7 centering pin
71 centering hole
72 material accumulation
73 material clearance
8 perpendicular bisector
9 connecting element with extended function
91 arrangement portion
92 outer portion
93 inner portion
98 functional portion
10 screw

1-23. (canceled)

24. A modular carrying system for carrying tools and/or workpieces so that they can be worked on, comprising:
a plurality of octagonal profiles each with eight side surfaces, which each have a multiplicity of arrangement holes,
wherein a plurality of the octagonal profiles are connected to one another via connecting elements to form a basic carrying structure,
wherein the connecting elements each have two arrangement portions, which each engage around three adjacent side surfaces of an octagonal profile,
wherein the connecting elements each connect two octagonal profiles in such a manner that the arrangement portions are each spaced apart from the central side surface of the three adjacent side surfaces of a respective octagonal profile and are arranged in a form-fitting manner on the outer side surfaces of the adjacent side surfaces of a respective octagonal profile via the arrangement holes in the outer side surfaces of the adjacent side surfaces.

25. The carrying system as claimed in claim 24, wherein at least some of the connecting elements are designed in the form of first connectors for the right-angled connection of two octagonal profiles in the same arrangement plane; and/or in that at least some of the connecting elements are designed in the form of second connectors for the right-angled connection of two octagonal profiles in arrangement planes which are offset parallel in relation to one another.

26. The carrying system as claimed in claim 24, wherein at least some of the first connectors and/or at least some of the second connectors connect two octagonal profiles with different widths across their flats; and/or in that at least some of the first connectors and/or at least some of the second connectors connect two octagonal profiles with the same width across their flats.

27. The carrying system as claimed in claim 25, wherein the arrangement portions of the first connectors are arranged at right angles in relation to one another and comprise continuous outer portions, which butt in a form-fitting manner against the outer side surfaces of the adjacent side surfaces, and inner portions, which connect the outer portions, wherein the outer portions have fastening holes, which are designed to correspond to the arrangement holes.

28. The carrying system as claimed in claim 27, wherein the inner portions of the first connectors each have a clearance.

29. The carrying system as claimed in claim 27, wherein the first connectors have a connecting crosspiece, which connects the outer ends of the inner portions.

30. The carrying system as claimed in claim 29, wherein a connecting crosspiece of a respective first connector which connects to one another two octagonal profiles with the same width across their flats tapers in the direction of its center.

31. The carrying system as claimed in claim 29, wherein a connecting crosspiece of a respective first connector which connects to one another two octagonal profiles with different widths across their flats tapers in the direction of the octagonal profile with the smaller width across its flats.

32. The carrying system as claimed in claim 29, wherein a connecting crosspiece of a respective first connector is connected to the inner portions via a continuously formed-on portion.

33. The carrying system as claimed in claim 27, wherein the clearances of the inner portions are dimensioned in such a manner that, in order for the first connectors to be mounted on the octagonal profiles, the first connectors can be centered via centering pins introduced into the clearances and/or, in order for the first connectors to be removed from the octagonal profiles, centering pins can be introduced into the clearances.

34. The carrying system as claimed in claim 24, wherein the arrangement portions of the second connectors are spaced apart from one another via a connecting structure and, as seen in respect of a common perpendicular bisector, are arranged orthogonally in relation to one another, wherein the arrangement portions of the second connectors have continuous second outer portions, which butt in a form-fitting manner against the outer side surfaces of the adjacent side surfaces and have second fastening holes, which are designed to correspond to the arrangement holes, wherein the second outer portions are connected to one another via the connecting structure.

35. The carrying system as claimed in claim 34, wherein there is a clearance between the second outer portions of a respective arrangement portion.

36. The carrying system as claimed in claim 34, wherein the connecting structure has ribs, which connect the second outer portions of a respective arrangement portion.

37. The carrying system as claimed in claim 36, wherein the ribs each extend between a longitudinal side and an end side of the adjacent second outer portions.

38. The carrying system as claimed in claim 36, wherein there is a clearance between the inner ribs.

39. The carrying system as claimed in claim 36, wherein there is a recess between the outer ribs, the recess having a connecting surface which connects the outer ribs.

40. The carrying system as claimed in claim 36, wherein the outer ribs are of curved design and/or the inner ribs are of rectilinear design.

41. The carrying system as claimed in claim 23, wherein at least some of the connecting elements each have at least one centering pin, wherein the at least one centering pin engages in an arrangement hole in the respective octagonal profile.

42. The carrying system as claimed in claim 23, wherein at least some of the octagonal profiles each have a material accumulation in the interior, beneath the side surfaces, wherein the arrangement holes pass through the material accumulation and the arrangement holes have an internal thread.

43. The carrying system as claimed in claim 23, wherein at least some of the connecting elements are arranged on the octagonal profiles by way of screws with an anti-friction coating.
